(19) United States
(12) Patent Application Publication
(10) Pub. No.: US 2011/0084844 A1
(43) Pub. Date: Apr. 14, 2011

(54) SMOKE AND CARBON MONOXIDE DETECTOR DEVICE

(76) Inventor: Richard E. Carnation, Windsor, CA (US)

(21) Appl. No.: 12/578,672

(22) Filed: Oct. 14, 2009

(51) Int. Cl. G08B 17/10; G08B 23/00

(52) U.S. Cl. 340/628; 340/693.1; 340/693.6

(57) ABSTRACT

A sensor device for the detection of smoke and carbon monoxide. Smoke and carbon monoxide detecting elements are placed within a housing which also contains a rechargeable power source for powering the detector elements The housing is provided with a first interface to engage a lighting fixture and a second interface for engaging a light source. Upon applying electric current to the lighting fixture, power is applied to the sensor device for charging the rechargeable power source and for illuminating the light source.

### TECHNICAL FIELD

The present invention is directed to sensor devices for sensing smoke and/or carbon monoxide. The present invention is easy to install and remove from both residential and commercial spaces as it can be applied to commonly available lighting fixtures rather than having to be separately installed onto a structural surface further requiring the extension of electrical service to the device. In adopting the present invention, the need for appropriate detection elements can be satisfied without having to engage the services of a contractor or specialty installer. Further, when the present invention is used in connection with a typical lighting source which also includes a shade or globe, the present detector can be employed without visual impact

### BACKGROUND OF THE INVENTION

The use of smoke detectors as well as carbon monoxide detectors have become much more common and widespread than in the past. Many jurisdictions require smoke detectors be strategically placed within both residential and commercial buildings at the time of construction or during remodeling recognizing that such devices can and oftentimes do save lives Similarly, carbon monoxide detectors have become more widespread recognizing that carbon monoxide, although deadly, is an odorless gas preventing one's senses from recognizing the inherent danger.

Although, as noted above, use of smoke and carbon monoxide detectors are widespread, installation of such devices can often be costly and obtrusive, particularly when they are installed within pre-existing structures. A smooth, attractively pleasing ceiling or one which possesses ornate features, can be compromised by such a device, the shape and size of which is oftentimes dictated by functional rather than aesthetic considerations. In addition, installation oftentimes requires a skilled contractor for electrical service must be extended from a pre-existing source to the detector which is placed in strategic locations to maximize detection Aesthetic and cost considerations will, in some instances, disway a potential user from installing a detector even though such a decision could prove fatal

It is thus an object of the present invention to provide smoke and/or carbon monoxide detectors which overcome the short comings discussed above.

It is yet a further object of the present invention to provide smoke and/or carbon monoxide detectors which can be installed by a user without the need for a professional installer

It is yet a further object of the present invention to provide a smoke and/or carbon monoxide detector which can be installed within pre-existing lighting fixtures thus obviating the need for any modification to pre-existing electrical service.

These and further objects will be more readily apparent when considering the following disclosure and appended drawings.

### SUMMARY OF THE INVENTION

A sensor device for the detection of smoke and carbon monoxide. Smoke and carbon monoxide detecting elements are placed within a housing which also contains a rechargeable power source for powering the detector elements The housing is provided with a first interface to receive power and a second interface for receiving a light source. Upon applying electric current to the first interface, power is applied to the sensor device for charging the rechargeable power source and for illuminating the light source

### BRIEF DESCRIPTION OF THE FIGURES

FIGS. 1-4 are perspective and exploded views of various embodiments of the present invention.

FIG. 5 is a side perspective view of the present invention used in conjunction with a lighting fixture having a globe or shade as a further embodiment thereof.

FIG. 6 is the layout of a basic parts schematic highlighting the various elements of the present invention.

### DETAILED DESCRIPTION OF THE INVENTION

For purposes of illustration only, the present invention is depicted in the appended drawings as interfacing a standard incandescent lighting fixture with an incandescent bulb. It must be appreciated, however, that this invention can be employed between any power and light source as the present invention can be employed to detect smoke and/or carbon monoxide any place wherein lighting fixture is present.

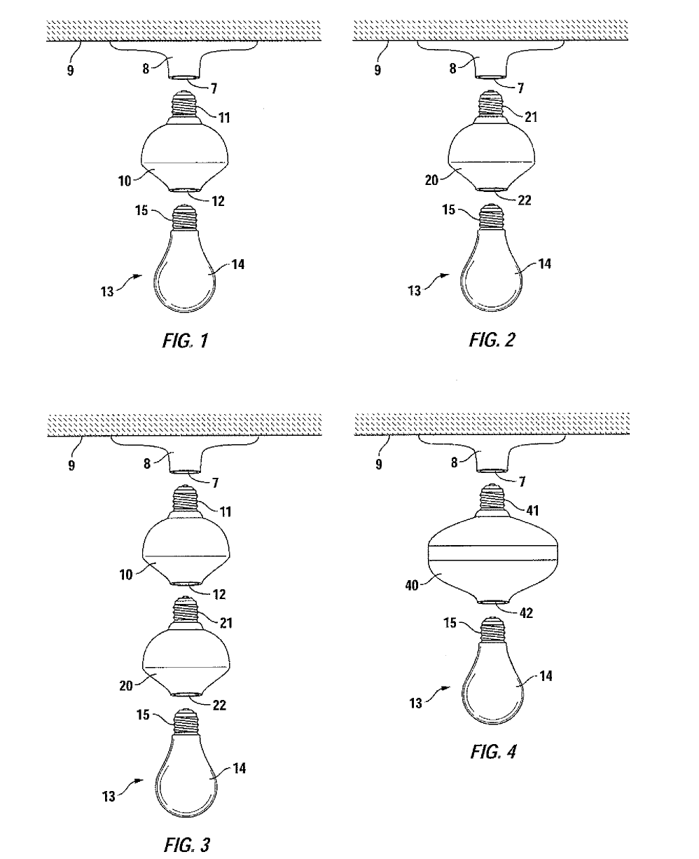

Turning first to FIG. 1, the present invention is intended to engage and be supported by lighting fixture 8 typically appended to ceiling 9 The smoke detector sensor of the present invention is contained within housing 10 having various smoke detector and rechargeable power source elements, the details of which will be discussed in reference to FIG. 6.

Housing 10 includes first interface 11 sized to engage lighting fixture 8 through power source 7. Housing 10 is further provided with second interface 12 sized to receive light source 13. In the illustrated example, threaded male member 15 is joined to lamp portion 14.

When considering FIG. 1, it should be readily apparent that the smoke detector contained within housing 10 can readily and conveniently be installed wherever fixture 8 is located by merely detaching lamp 13 from power source 7, installing the smoke detector within fixture 8 and then applying lamp 13 to the detector In a matter of perhaps less than a minute, one can thus convert a standard lamp fixture to one in which smoke detection is now available Further, when one flips on a light switch powering lamp 13 through fixture 8, lamp 13 will illuminate while, at the same time, rechargeable power sources within housing 10 are charged to ensure continuous operation of the appropriate detector elements contained therein.

The invention depicted in FIG. 2 is quite similar to that of FIG. 1. In fact, externally, housing 20 possessing first interface 21 and second interface 22, corresponding to interface members 11 and 12 of FIG. 1 However, in this instance, housing 20 can contain a carbon monoxide detector rather than the smoke detector of FIG. 1. Thus, for cost savings in installations where only carbon monoxide detection is needed, one can install only the carbon monoxide detection element within housing 20 and save costs inherent in the use of multiple detection elements Such may be the case where pre-existing smoke detection is already built into a structure but the structure is now being employed as either a garage or automotive repair facility or other activity where carbon monoxide generation is a real possibility. In such an instance, a user may opt to only install the carbon monoxide detector of FIG. 2. Conversely, when carbon monoxide detection is not a priority, a user can opt for the smoke detector of FIG. 1 and bypass the use of the FIG. 2 embodiment.

The present invention also contemplates the stacking of multiple detectors in thus enhancing the flexibility and usefulness of these devices. In this regard, reference is made to FIG. 3 whereby smoke detection capability within housing 10 can be provided through its direct engagement to lighting fixture 8 by applying first interface 11 to power source 7 Instead of light source 13 being installed within second interface 12 as described with regard to FIG. 1, first interface 21 of housing 20 containing a carbon monoxide detector is mated to the smoke detector element whereupon light source 13 is applied to the carbon monoxide detector by applying element 15 to second interface 22. Upon the application of power to lighting fixture 8, both detectors as well as the light source are powered.

As an alternative to the use of stacked sensors as illustrated in FIG. 3, it is proposed, as yet a further embodiment, that both sensors be contained within a single housing. In this regard, reference is made to FIG. 4 wherein housing 40 can be made to contain both smoke and carbon monoxide sensors which are powered by applying first interface member 41 to power source 7 within lighting fixture 8. As in previous embodiments, housing 40 can include second interface 42 for the receipt of member 15 for powering light source lamp 13. Thus, a consumer can opt to install a single housing containing both smoke and carbon monoxide detection or only carbon monoxide detection or only smoke detection and, in the latter instances, add other detection elements singularly or in combination as the need arises.

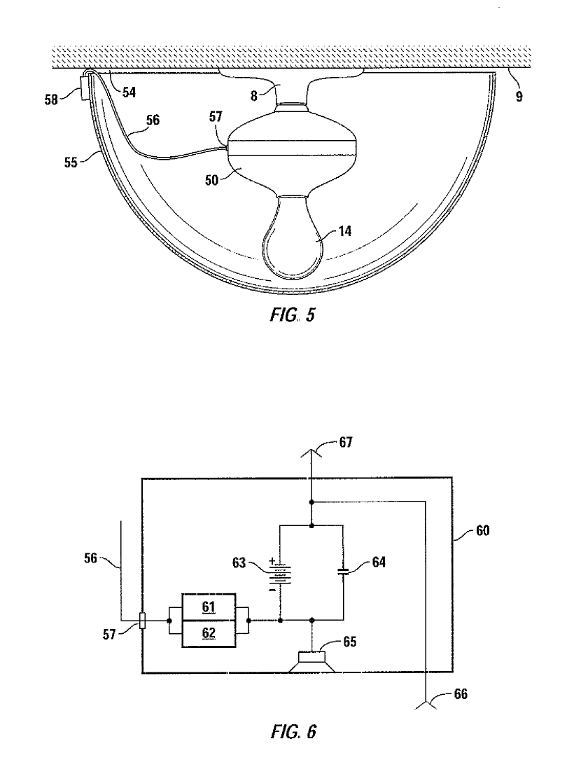

As yet a further embodiment, reference is made to FIG. 5. In this instance, lighting fixture 8 is surrounded, for aesthetic considerations, by shade or globe 55 This is very common particularly in residential installations where most occupants would rather shade a lamp than expose it directly. However, when housing 50 containing smoke and/or carbon monoxide detector elements is applied to lighting fixture 8, globe or shade 55 may act to reduce the efficiency of the detector device as smoke and/or carbon monoxide may be shielded from the detector. In dealing with this contingency, housing 50 is provided with interface 57 from which umbilical 56 passes extending through globe or shade support 54 and terminating outside of globe or shade 55 with sensor element(s) 58. In doing so, smoke and/or carbon monoxide within the ambient surroundings would be sensed as if globe or shade 55 was not present.

In turning to FIG. 6, it is noted that power emanating through lighting fixture 8 would be introduced as power source 66. Within circuit topography 60, power from source 66 would then extend to element 67 intended to apply current to interface members 12, 22 and 42 as discussed above Simultaneously, power would be applied to either rechargeable battery 63 and/or capacitor 64 for powering smoke detector and/or carbon monoxide detector elements 61 and 62, respectively Obviously, the present invention, as noted above, could include either smoke detector element 61 or carbon monoxide detector element 62, individually (FIGS. 1, 2 and 3) or together in a single housing (FIG. 4) Further, the present invention need not contain both rechargeable battery 63 and capacitor 64 as each element, taken alone, can act to store electrical energy for powering the sensor elements when power source 66 is terminated by a user simply flipping off a light switch when deciding to turn off a light source. Finally, umbilical 56 can engage the present structure by removably inserting it within receptacle 57 for remote access to the appropriate sensor elements as discussed with regard to FIG. 5.

Turning once again to FIG. 6, it is noted that the present invention further includes sound chip 65 shown as a single element although different sound chips can be employed while remaining within the spirit and scope of the present invention. Obviously, the first function of sound chip 65 is to alert a user of the presence of smoke and/or carbon monoxide in the event that these materials are detected in sufficient concentrations to justify an alert. In addition, in that sound chip 65 is bridged to not only sensor element 61 and 62 but also rechargeable power sources 63 and 64, it is intended, as preferred embodiments, that sound chip 65 emanate a sound such as a “chirp” whenever power is introduced at 66 to remind a user that appropriate sensing is taking place. Further, when rechargeable sources 63 and 64 become dissipated generally due to a long dormancy period where no power is applied to the present invention, a periodic sound can emanate from the device to remind a user to flip the appropriate wall switch to apply power to rechargeable sources 63 and 64 to ensure proper operation of the sensing elements.

It is to be understood that the present invention is not limited to the embodiments described above, but encompasses the full scope of the claims which follow. For example, although applicant has indicated that the present invention is to include smoke and/or carbon monoxide sensing elements, other sensors such as heat sensors can be included within such a device while remaining within the spirit and scope of the present invention for detecting elevated temperatures which may present themselves to the sensor without concurrent smoke and/or carbon monoxide evolution.

What is claimed is:

1. A sensor device for the detection of smoke comprising a housing containing a smoke detector element and a rechargeable power source for powering said smoke detector element, a first interface of said housing sized to engage a lighting fixture and a second interface of said housing sized for receiving a light source wherein upon applying electric current to said lighting fixture, power is applied to said sensor device for charging said rechargeable power source and for illuminating said light source

2. The sensor device of claim 1 wherein said rechargeable power source comprises a rechargeable battery.

3. The sensor of claim 1 wherein said rechargeable power source comprises a capacitor.

4. The sensor of claim 1 further comprising a signal generator for generating an audible signal upon applying electric current to said lighting fixture.

5. The sensor of claim 1 further comprising a signal generator for generating an audible signal when said rechargeable power source is low in power and requires recharging to maintain functioning of said device

6. The sensor device of claim 1 wherein said smoke detector element is located on a wire extending from said housing to enable smoke detection remotely from said housing.

7. The sensor device of claim 1 further comprising a second housing containing a carbon monoxide detector element and a second rechargeable power source for powering said carbon monoxide detector element, a first interface within said second housing sized to engage said second interface of said first member and a second interface within said second housing sized for engaging a light source where upon applying electric current to said lighting fixture, power is applied for charging said second rechargeable power source and for illuminating said light source.

8. The sensor of claim 7 wherein said carbon monoxide detector element is located on a wire extending from said second housing to enable carbon monoxide detection remotely from said housing

9. A sensor device for the detection of carbon monoxide comprising a housing containing a carbon monoxide detector element and a rechargeable power source for powering said carbon monoxide detector element, a first interface of said housing sized to engage a lighting fixture and a second interface of said housing sized for interfacing a light source wherein upon applying electric current to said lighting fixture, power is applied to said sensor device for charging said rechargeable power source and for illuminating said lighting source.

10. The sensor device of claim 9 wherein said rechargeable power source comprises a rechargeable battery.

11. The sensor of claim 9 wherein said rechargeable power source comprises a capacitor.

12. The sensor of claim 9 further comprising a signal generator for generating an audible signal upon applying electric current to said lighting fixture.

13. The sensor of claim 9 further comprising a signal generator for generating an audible signal when said rechargeable power source is low in power and requires recharging to maintain functioning of said device.

14. The sensor device of claim 9 wherein said carbon monoxide detector element is located on a wire extending from said housing to enable carbon monoxide detection remotely from said housing

15. The sensor device of claim 9 further comprising a second housing containing a smoke detector element and a second rechargeable power source for powering said smoke detector element, a first interface of said second housing sized to engage said second interface of said first housing and a second interface of said second member sized for interfacing a light source whereupon in applying electric current to said lighting fixture, power is applied for recharging said second rechargeable power source and for illuminating said light source.

16. The sensor device of claim 15 wherein said smoke detector element is located on a wire extending from said second housing to enable smoke detection remotely from said housing.

17. A sensor device for the detection of smoke and carbon monoxide comprising a housing containing smoke and carbon monoxide detector elements and a rechargeable power source for powering said elements, a first interface of said housing sized to engage a lighting fixture and a second interface of said housing sized for interfacing with a light source whereupon in applying electric current to said lighting fixture, power is applied to said sensor device for charging said rechargeable power source and for illuminating said light source.

18. The sensor device of claim 17 wherein said rechargeable power source comprises a rechargeable battery.

19. The sensor device of claim 17 wherein said rechargeable power source comprises a capacitor.

20. The sensor device of claim 17 further comprising a signal generator for generating an audible signal upon applying electric current to said lighting fixture

21. The sensor device of claim 17 thither comprising a signal generator for generating an audible signal when said rechargeable power source is low in power and requires recharging to maintain functioning of said device.

22. The sensor device of claim 17 wherein said smoke and carbon monoxide detector elements are located on a wire extending from said housing to enable smoke detection remotely from said housing.
